(19) United States
(12) Patent Application Publication
(10) Pub. No.: US 2013/0262068 A1
(43) Pub. Date: Oct. 3, 2013

(54) SENSOR PLACEMENT FOR LEAKAGE LOCATION IN LIQUID DISTRIBUTION NETWORKS

(71) Applicants: Eitan Israeli, Haifa (IL); Yossi Shiloach, Aviel (IL); Ofer Shir, Jerusalem (IL); Segev Wasserkrug, Haifa (IL); Ran Weisman, Segev Atzmon (IL)

(72) Inventors: Eitan Israeli, Haifa (IL); Yossi Shiloach, Aviel (IL); Ofer Shir, Jerusalem (IL); Segev Wasserkrug, Haifa (IL); Ran Weisman, Segev Atzmon (IL)

(73) Assignee: INTERNATIONAL BUSINESS MACHINES CORPORATION, Armonk, NY (US)

(21) Appl. No.: 13/431,998

(22) Filed: Mar. 28, 2012

(51) Int. Cl. G06G 7/50; G06F 17/50

(52) U.S. Cl. 703/9

(57) ABSTRACT

A computerized method of identifying a deployment of a plurality of hydraulic sensors in a liquid distribution network, optionally according to leakage detection performance. The method comprises receiving a topology model mapping a plurality of components of a liquid distribution network, assigning at least one leakage potential variable to each of the plurality of components, receiving a plurality of sensor placement configurations, each defining a deployment of a plurality of hydraulic sensors in the liquid distribution network according to the plurality of components, conducting a plurality of simulations of a plurality of leakage scenarios on each of the plurality of sensor placement configurations, according to the respective plurality of leakage potential variables, selecting a recommended sensor placement configuration from the plurality of sensor placement configurations according to the plurality of simulations, and outputting instructions for hydraulic sensor deployment in the liquid distribution network according to the recommended sensor placement configuration.

### BACKGROUND

The present invention, in some embodiments thereof, relates to leakage detection in liquid distribution network and, more specifically, but not exclusively, to deployment of leakage detection means in liquid distribution network designs.

Liquid distribution networks are used in the transportation of water, sewer, oil and other liquid substances to multiple locations. Pipelines within such networks have to adhere to high demands of safety, reliability and efficiency. Timely detection of man caused leaks such as sabotage or theft, as well as natural leaks such as at poor construction joints, corrosion points and structural material cracks, are critical to the ongoing performance of the network.

A leak detection system is an integral part of pipeline technology which contributes to reducing pipeline downtime and inspection time. Such a system assists pipeline controllers in detecting leaks and pinpointing their locations within the liquid distribution network by aggregating and analyzing data from field sensing instrumentation such as flow sensors, temperature sensors, infrared radiometers, thermal cameras or the like.

Leak identification schemes depend upon the spatial placement of sensing instrumentation, mainly the number and location of sensors within the liquid distribution network.

Currently, sensor placement within liquid distribution networks is a manual process based on trial and performance assessment. Each sensor installation has a cost, and thus sensor placement often relies on existing instrumentation in the network, that had been installed according to various considerations. Sample considerations such as existing turnouts in the proximity of water tanks are not necessarily conducive to leak detection. Therefore, the current state is that cost-efficiency and accuracy of the sensing instrumentation are not taken into account during the placement process.

### SUMMARY

According to an aspect of some embodiments of the present invention there is provided a computerized method of identifying a deployment of a plurality of hydraulic sensors in a liquid distribution network. The method comprises receiving a topology model mapping a plurality of components of a liquid distribution network, each component being assigned with at least one leakage potential variable, receiving a plurality of sensor placement configurations, each defining a deployment of a plurality of hydraulic sensors in the liquid distribution network according to the plurality of components, conducting a plurality of simulations of a plurality of leakage scenarios on each of the plurality of sensor placement configurations, according to the respective at least one leakage potential variable, selecting a recommended sensor placement configuration from the plurality of sensor placement configurations according to the plurality of simulations, and generating instructions for hydraulic sensor deployment in the liquid distribution network according to the recommended sensor placement configuration.

According to an aspect of some embodiments of the present invention there is provided a system for locating hydraulic sensors in a liquid distribution network. The system comprises a processor, an interface module which receives a topology model mapping a plurality of components of a liquid distribution network and an association between at least one leakage potential variable and each of the plurality of components, a sensor configuration definition module which receives a plurality of sensor placement configurations each defining a deployment of a plurality of hydraulic sensors deployed in the plurality of components, a leakage scenario simulation module which simulates a plurality of leakage scenarios for a each of the plurality of sensor placement configurations according the at least one leakage potential variable, and a sensor configuration selection module which selects a recommended sensor placement configuration from the plurality of sensor placement configurations.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for designing the deployment of hydraulic sensors in a liquid distribution network, according to some embodiments of the present invention;

FIG. 2 is a relational view of software and hardware components of a system for locating hydraulic sensors in a liquid distribution network, according to some embodiments of the present invention; and

FIG. 3 is a diagram illustrating the input and output of a leakage detection simulation module, according to some embodiments of the present invention.

### DETAILED DESCRIPTION

The present invention, in some embodiments thereof, relates to leakage detection in liquid distribution networks and, more specifically, but not exclusively, to deployment of leakage detection means in liquid distribution network designs.

According to some embodiments of the present invention, there are provided methods and systems of designing the deployment of hydraulic sensor(s) in a liquid distribution network according to leak detection timing and accuracy data. In some embodiments, the methods and systems acquire a topology model defining a liquid distribution network design according to different components such as but not limited to numbers and locations of nodes acting as network endpoints, pipes, joints and reservoirs. Other parameters may also be acquired, for example and without limitation liquid demand patterns of the network nodes. According to the topology model, multiple leakage scenarios are simulated with respect to different placement configurations of hydraulic sensors, also referred to herein as sensor placement configurations. Each sensor placement configuration reflects a deployment of optional selection of hydraulic sensors' types and their positioning with respect to components of the liquid distribution network. Hydraulic sensors may be, for example, flow meters, pressure gauges, tank-level readers which measure liquid levels inside liquid reservoirs, and any other available hydraulic sensing instruments.

In some embodiments, the methods and systems create instructions of mapping a placement configuration of hydraulic sensor(s) according to the different components of the liquid distribution network and their leakage potential, optionally within the limits of a given budget and/or based on a given pool of hydraulic sensors. Each sensor placement configuration includes the quantities and types of hydraulic sensors to be placed within the liquid distribution network, inside, on top and in between the different components of the liquid distribution network. A sensor placement configuration is selected according to an assessment of the tradeoffs between the fidelity, accuracy and response time of leakage detection and the cost of purchase and installation of the hydraulic sensors.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

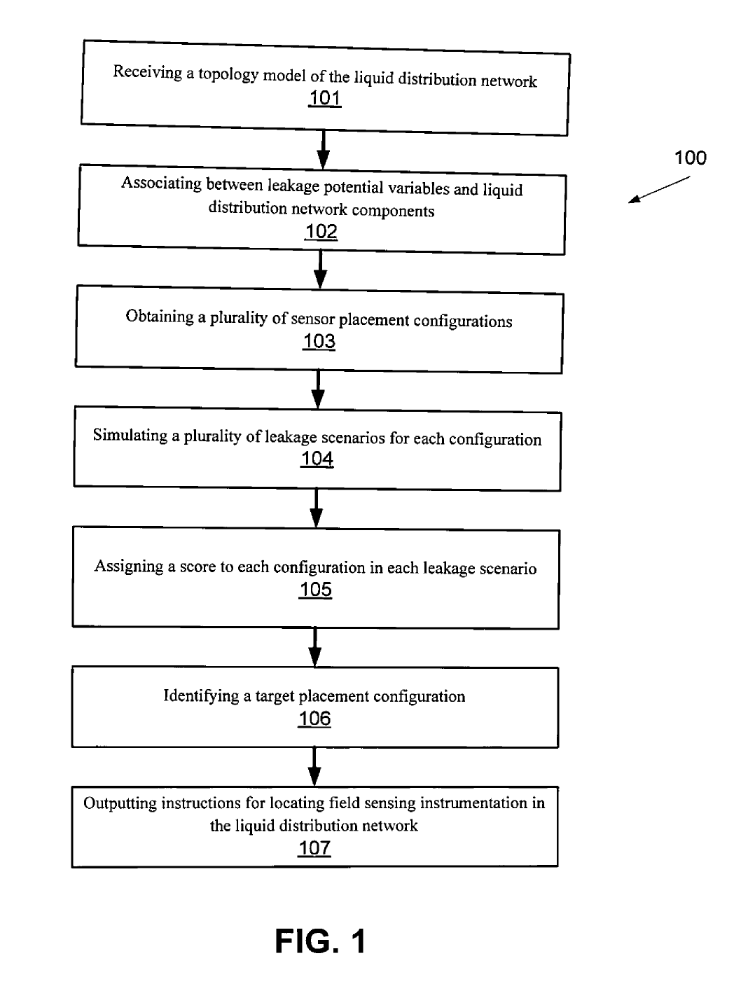

Reference is now made to FIG. 1, which is a flowchart of a method 100 for designing the deployment of hydraulic sensors in a liquid distribution network based on leak detection timing and accuracy data, according to some embodiments of the present invention.

The method 100 is based on a received topology model defining the components of the liquid distribution network, data pertaining to leakage potential variables of components, possible leakage scenarios, and optional sensor placement configurations.

Each leakage scenario is defined as a leakage event and/or series of leakage events in one or more components of the liquid distribution network. Leakage events may occur in joints, for example poorly connected joints, blocked or damaged pipes, collapsing and/or rusty network components and/or the like. The method is based on simulating leakage scenarios for each of optional sensor placement configurations, and using leakage identification analytics module(s) such as a hydraulic solver to assess the effectiveness and accuracy data of each sensor placement configuration in detecting leaks within the liquid distribution network. The method makes a cost-effective selection of a sensor placement configuration for the liquid distribution network. The method facilitates identifying a recommended hydraulic sensor placement configuration of hydraulic sensors for automatic leakage identification with a high return on investment (ROI) in the liquid distribution network. The identified recommended sensor placement configuration consists of a number of hydraulic sensors, the type of each hydraulic sensor in the recommended sensor placement configuration and the location of each hydraulic sensor in the recommended sensor placement configuration and/or the like. Overall hydraulic sensor utility within the liquid distribution network, defined as the ratio between leakage detection efficiency and deployment and/or maintenance cost, is increased to the degree desired by the decision maker employing the systems and methods, by accounting for the fidelity of the leakage detection process according to the attained tradeoff.

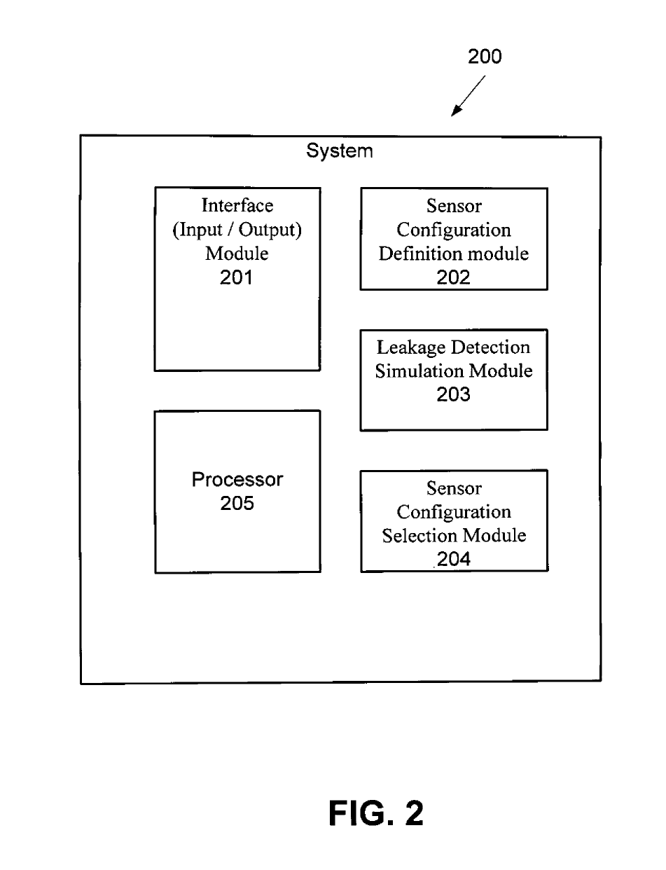

Reference is also made to FIG. 2, which is a relational view of software and hardware components of a system 200 for deploying hydraulic sensors in a liquid distribution network, according to some embodiments of the present invention. The system 200 includes an interface 201 serving as an input and/or output module, a sensor configuration definition module 202, a leakage scenario simulation module 203, a sensor configuration selection module 204 and a processor 205. For brevity, it should be noted that computing functions described herein may be performed using the processor 205.

The method 100 and system 200 may be implemented as a liquid distribution network design platform, an add-on to an existing network design platform, and/or as a software as a service (SaaS) which provides services for users via client terminals.

As shown in numeral 101 of FIG. 1, the interface 201 acquires, for example receives or accesses, a topology model of a liquid distribution network having a plurality of components such as but not limited to pipes, junctions and reservoirs. The topology model maps the spatial arrangement of the components within the liquid distribution network and optionally physical attributes of connection points between the components and/or the like. Optionally, the topology model maps one or more physical attributes of each one of the liquid distribution network components, for example and without limitation numbers and locations of network nodes, pipes' lengths and diameters, reservoirs' overall shapes and depths, the materials from which the components are made. Other components may also be acquired, for example and without limitation liquid demand patterns of the network nodes.

As shown at 102, the network topology model assigns some or all of the liquid distribution network components one or more leakage potential variables. Optionally, the system 200 includes or is connected to a module that analyzes mechanical and physical attributes of the topology of the liquid distribution network, for example as known in the art, and provides the one or more leakage potential variables for the liquid distribution network components, as described above. Leakage potential variables may include flow variables of virtual nodes, which would get zero values when no leakage is detected or non-zero values when leakage occurs in the proximity of the components' spatial coordinates. Leakage potential may be affected by aging variables of the liquid distribution network, connection quality of joints, proximity of components to water reservoirs within the liquid distribution network, corrosion variables of pipes, pressure-dependent flow throughout holes, or the like.

As shown in numeral 103, a sensor configuration definition module 202 acquires, for example calculates, receives or accesses, a candidate set of hydraulic sensor placement configurations within the liquid distribution network. Each of the hydraulic sensor placement configurations defines a different arrangement of hydraulic sensors deployed inside, on top and in between the different components of the liquid distribution network. In some embodiments, sensor configuration definition module 202 receives sensor placement configuration data from an external unit, for example by establishing a communication session with an external mathematical module, for example as known in the art. Such mathematical modules may use techniques such as but not limited to random sampling of sensor placement configurations according to a the network topology model and a predefined set of sensors, or application of statistical learning algorithms to define candidate sensor placement configurations within a liquid distribution network.

In some embodiments, expense scores may be assigned to each of the sensor placement configurations. Each expense score reflects a cost of purchasing, placing, using and/or maintaining the hydraulic sensors in the liquid distribution network according to the sensor placement configuration. An expense score of a sensor placement configuration relates to the configuration regardless of the leakage scenario. A limited budget may be provided for a recommended sensor placement configuration, for example by an administrator of the liquid distribution network. If such a budget constraint is provided, sensor placement configurations whose costs exceed the budget may be declared as infeasible configurations and eliminated from the simulation and selection process. Such pre-elimination of incompatible budget configurations from the candidate set of hydraulic sensor placement configurations may reduce the overall simulation and selection time.

Then, as shown in numeral 104, a leakage scenario simulation module 203 iteratively simulates leakage scenarios in the liquid distribution network according to the leakage potential variables associated with the different network components. In each simulation, one leakage scenario and one sensor placement configuration is selected from the candidate set of hydraulic sensor placement configurations, such that part or all of the suggested sensor placement configurations are evaluated for each of the leakage scenarios. In some embodiments, in each of the simulation iterations a set comprising a plurality of candidate configurations may be drawn, simulated and evaluated. Higher ranking configurations may serve as a base for draws of subsequent sets of candidate configurations.

In each simulation, the leakage scenario simulation module 203 may use a leakage identification analytics module and simulated field measurements provided by each of the hydraulic sensors within a candidate sensor placement configuration to identify and locate leaks in the liquid distribution network topology. For example, leakage identification analytics may define a potential leak in a site where non-zero leakage flow would explain discrepancies between hydraulic measurements and the simulated field measurement values. Potential leakage identification analytics may relate to different network components, such as endpoints, pipes connecting different endpoints, junctions or the like. The leakage identification analytics module detects leaks within the liquid distribution network according to the candidate sensor configuration. The module may be internal to the system 200, or alternatively the system may be connected to an external hydraulic solver, for example as known in the art.

As shown in numeral 105, in each simulation, a detection performance score may be assigned to each of the sensor placement configurations in each of a number of simulated leakage scenarios. The detection performance score reflects the success rate of tackling the leakage scenario, and may be based on detection accuracy and detection timing of leakage scenarios in the selected configuration. Optionally, one or more detection tolerance thresholds can be provided to define accuracy of leakage detection. For example, if a spatial arrangement of hydraulic sensors in a sensor placement configuration is such that hydraulic sensors are placed one meter apart from each other, a spatial tolerance threshold of one meter in the spatial detection accuracy may be defined as acceptable. Optionally, a timing tolerance threshold may be provided for each leakage scenario, such that sensor placement configurations which provide detection timing data which does not exceed the timing tolerance threshold are defined as acceptable. An overall detection fidelity score may be assigned to each of the simulated sensor placement configurations. The detection fidelity score may be defined as the number of leaks that are accurately identified by the employed analytics divided by the correct number of leaks in the given scenario. Together with the sensor placement configuration's installation costs, the detection performance scores and detection fidelity score constitute the performance-measures of each candidate configuration.

Then, as shown in numeral 106, a sensor configuration selection module 204 selects a recommended sensor placement configuration according to the detection performance scores of each of the sensor placement configurations. Optionally, a leakage probability value may be assigned to each leakage scenario to reflect the occurrence likelihood of the scenario. The leakage probability value may be used in the sensor placement configuration selection process, such that more weight is associated with scenarios which are more likely to occur.

The selection module 204 may use budget constraints in the selection process, in which the expense score of the configuration is used in the selection process. For example, if a number of candidate sensor placement configurations show similar performance measures, the sensor placement configuration with the lowest expense score is selected. As shown in numeral 107, instructions for locating the sensors in the liquid distribution network are provided and outputted according to the selected sensor placement configuration.

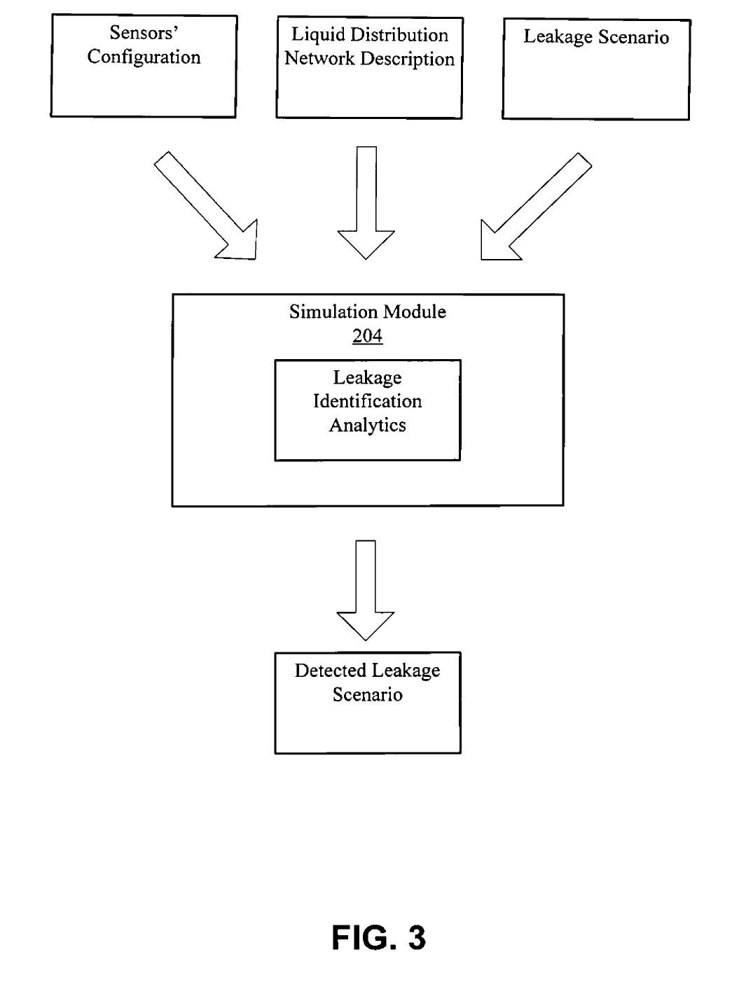

Reference is now made to FIG. 3, which is a diagram illustrating the input and output of a leakage detection simulation module, according to some embodiments of the present invention. The leakage scenario simulation module 204 is used to simulate and assess each sensor placement configuration according to a plurality of leakage identification analytics. The leakage detection simulation is iteratively repeated for a plurality of sensor placement configurations in a plurality of leakage scenarios.

The leakage detection simulation module 204 receives as input a candidate hydraulic sensor placement configuration, at least one input leakage scenario to be identified, and a liquid distribution network topology, for example that of a water or a sewer network. The simulation employs a leakage identification analytics module and produces as output a detected leakage scenario according to the candidate sensor placement configuration. The detected leakage scenario may be assessed and assigned a detection performance score reflecting its fit with the input leakage scenario. The fit may be defined as the number of leakage locations accurately defined by the leakage identification analytics module, using data received from the plurality of hydraulic sensors in the candidate sensor placement configuration, divided by the correct number of leaks in the given scenario.

Embodiments of the systems and methods offer a fully-automated solution for optimizing sensors' placement for cost-efficient and accurate leakage identification and leakage location on a given liquid distribution network, so as to best balance the leakage location accuracy and detection timing of leaks with the cost-efficiency of installing the hydraulic sensors. Optimization of the selection of the sensor placement configuration according to the tradeoff between the deployment and/or maintenance cost of hydraulic sensors on one hand, and the detection timing and detection accuracy on the other hand, can be achieved by defining and solving a single-objective or a multi-objective optimization problem. The -objective approach would obtain a single efficient configuration, whereas the multi-objective approach would obtain a set of Pareto efficient configurations that reflect the entire trade-off spectrum, or alternatively, the Efficiency Frontier of the problem. In the multi-objective approach, the decision maker would have to select a specific configuration from the set of Pareto efficient configurations according to their trade-off preferences.

The optimization problem may be presented as a single-objective optimization problem striving to minimize the overall sensor placement configuration cost defined by an expense score, while the detection performance score defined by detection timing data and leak detection accuracy data of leakage identification in the different leakage scenarios is taken into account as a set of constraints. A possible realization of such constraints may be formulated as an alignment of the simulated measurement readings to corresponding values prescribed by a hydraulic solver during a leakage location procedure to account for the potential leakage parameters. The instantiation of the multi-objective optimization problem may be accomplished by various schemes. A formulation of the multi-objective optimization problem would necessitate an additional objective function, which may be presented as an error function for the aforementioned realization of the constraints.

A formulation of the optimization problem may require the following definitions:

A set of simulated sensor readings at S hydraulic sensor locations per scenario t may be defined as {πₖ(t)}ₖ₌₁^{S}.

The total installation and operational costs of hydraulic sensors of the i^{th} type may be defined as {cⱼⁱ}ⱼ₌₁^{S}.

Binary decision variables indicating the selection of hydraulic sensors of the i^{th} type in the j^{th} location: {xⱼ⁽ⁱ⁾}ⱼ₌₁^{S}

A set of randomly generated leakage scenarios are defined as t=1K T

The formulation of the single-objective problem can be presented as:

minimize′({xⱼ⁽ⁱ⁾}_{i,j})= [symbol] _{j,i}xⱼ⁽ⁱ⁾cⱼⁱ

Subject to:

Pᵣ(t)=πᵣ(t)r=1KS,t=1KT

with {Pᵣ(t)}ᵣ₌₁^{S} as the estimated hydraulic values per the various scenarios, given by a hydraulic solver during the leakage location procedure.

Alternatively, still within the single-objective framework, this optimization problem may be re-formulated as follows:

$$minimize ( {f}_{weighted} ) = {w}_{1} \cdot ( {\sum }_{j , i} {x}_{j}^{( i )} \cdot {c}_{j}^{i} ) + {w}_{2} \cdot ( {\sum }_{t = 1}^{T} [ {\sum }_{r = 1}^{S} {( {P}_{r} ( t ) - {π}_{r} ( t ) )}^{2} ] )$$

Alternatively, Pareto optimization approach may be utilized in order to address a bi-objective problem:

$$minimize ( {f}_{1} , {f}_{2} )$$

$${f}_{1} = {\sum }_{j , i} {x}_{j}^{( i )} \cdot {c}_{j}^{i}$$

$${f}_{2} = {\sum }_{t = 1}^{T} [ {\sum }_{r = 1}^{S} {( {P}_{r} ( t ) - {π}_{r} ( t ) )}^{2} ]$$

where f₁ reflects the configuration costs and where f₂ reflects the detection accuracy and/or fidelity.

Optionally, systems and methods employ an Evolutionary Algorithm for global optimization. The algorithm encodes the aforementioned decision variables of the optimization problem into bit strings of candidate solutions, indicating which hydraulic sensors in specific locations are to be installed or otherwise not installed. The selection of such recommended sensor placement configuration is achieved by defining a single-objective or multi-objective problem, optimizing the cost associated with placing the hydraulic sensors within the liquid distribution network according to the recommended sensor placement configuration.

A relevant sample Evolutionary Algorithm which may be employed is described by Bäck & Schutz in their publication “Evolution Strategies for Mixed Integer Optimization of Optical Multilayer Systems” (Evolutionary Programming IV Proc. Fourth Annual Conf. Evolutionary Programming, The MIT Press (1995) 33-51).

The systems and methods described herein may be used to update sensor placement configuration within a liquid distribution network, for example adding to or adjusting an existing hydraulic sensor deployment. For example, in a changing liquid distribution network topology more nodes and pipes may be added to the network. The existing recommended sensor placement configuration is re-evaluated according to the topology changes using a similar or a new set of leakage scenarios. The changes to the network are monitored, and the method is applied according to a new topology model defining the updated arrangement of liquid distribution network components.

In other examples, an existing sensor placement configuration may be assessed periodically against real-life measurements, such that when leakage detection timing, accuracy or fidelity of an existing sensor placement configuration drops, or alternatively when a sensor configuration budget increases, the systems and methods may be used to suggest alternative sensor placement configurations, optionally based on the existing recommended sensor placement configuration.

Embodiments of the systems and methods described herein allow a shift from a human-driven, trial-and-error-based process of sensor placement within a liquid distribution network to automated process for calculating a solution which employs a near-optimal, cost-effective placement schema which maintains the accuracy and fidelity of the leakage detection process within the network.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms a processor and a sensor is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of identifying a deployment of a plurality of hydraulic sensors in a liquid distribution network, the method comprising:
receiving a topology model mapping a plurality of components of a liquid distribution network, each said component being assigned with at least one leakage potential variable;
receiving a plurality of sensor placement configurations, each defining a deployment of a plurality of hydraulic sensors in said liquid distribution network according to said plurality of components;
conducting a plurality of simulations of a plurality of leakage scenarios on each of said plurality of sensor placement configurations, according to respective said at least one leakage potential variable;
selecting a recommended sensor placement configuration from said plurality of sensor placement configurations according to said plurality of simulations; and
generating instructions for hydraulic sensor deployment in said liquid distribution network according to said recommended sensor placement configuration.

2. The method of claim 1, further comprising assigning a detection performance score for each of said plurality of sensor placement configurations with respect to each of said plurality of leakage scenarios and selecting said recommended sensor placement configuration from said plurality of sensor placement configurations according to said detection performance score.

3. The method of claim 2, wherein said detection performance score is determined according to a target function based on at least one of leakage detection timing data and accuracy data.

4. The method of claim 2, further comprising receiving at least one detection tolerance threshold defining accuracy of leakage detection and determining said detection performance score according to said at least one detection tolerance threshold.

5. The method of claim 1, further comprising associating between said plurality of leakage scenarios and respective plurality of leakage probability values each reflecting the occurrence likelihood of each of said plurality of leakage scenarios, and wherein a recommended sensor placement configuration from said plurality of sensor placement configurations is selected according to said plurality of leakage probability values.

6. The method of claim 1, further comprising assigning at least one expense score to each of said plurality of sensor placement configurations, and wherein said recommended sensor placement configuration from said plurality of sensor placement configurations is selected according to said at least one expense score.

7. The method of claim 6, wherein said at least one expense score for each of said plurality of sensor placement configurations is determined according to a target function based on at least one of the cost of purchasing, deploying, operating and maintaining each of said plurality of sensor placement configurations within said liquid distribution network.

8. The method of claim 7, further comprising receiving a target budget for locating hydraulic sensors in a liquid distribution network, and wherein selecting said recommended sensor placement configuration from said plurality of sensor placement configurations comprises computing said target function according to said target budget.

9. The method of claim 1, wherein said recommended sensor placement configuration is selected according to at least one of a single-objective optimization procedure and a multi-objective optimization procedure.

10. The method of claim 1, wherein each of said plurality of hydraulic sensors is selected from a group consisting of flow meters, pressure gauges, and tank level readers.

11. The method of claim 1, wherein said leakage potential variables associated with each of said plurality of components receive non-zero values when leakage is detected in the proximity of said component's spatial coordinates.

12. The method of claim 1, further comprising monitoring topology changes in said liquid distribution network and evaluating said recommended sensor placement configuration according to said topology changes.

13. A computer program product for locating hydraulic sensors in a liquid distribution network, said computer program product comprising:
a computer readable storage medium;
first program instructions to obtain a topology model mapping a plurality of components assembling the liquid distribution network and receive a plurality of sensor placement configurations, each defining an arrangement of a plurality of hydraulic sensors deployed in said liquid distribution network according to said plurality of components;
second program instructions to assign at least one leakage potential variable to each of said plurality of components;
third program instructions to conduct a plurality of simulations of a plurality of leakage scenarios on each of said plurality of sensor placement configurations, according to respective said at least one leakage potential variable; and
fourth program instructions to select a recommended sensor placement configuration from said plurality of sensor placement configurations according to said plurality of simulations;
wherein said first, second and third program instructions are stored on said computer readable storage medium.

14. A system for locating hydraulic sensors in a liquid distribution network, the system comprising:
a processor;
an interface module which receives a topology model mapping a plurality of components of a liquid distribution network and an association between at least one leakage potential variable and each of said plurality of components;
a sensor configuration definition module which receives a plurality of sensor placement configurations each defining a deployment of a plurality of hydraulic sensors deployed in said plurality of components;
a leakage scenario simulation module which simulates a plurality of leakage scenarios for a each of said plurality of sensor placement configurations according said at least one leakage potential variable; and
a sensor configuration selection module which selects a recommended sensor placement configuration from said plurality of sensor placement configurations.

15. The system of claim 14, wherein said leakage scenario simulation module assigns at least one detection performance score for each of said plurality of sensor placement configurations with respect to each of said plurality of leakage scenarios and wherein said sensor configuration selection module selects a recommended sensor placement configuration from said plurality of sensor placement configurations according to said at least one detection performance score.

16. The system of claim 14, wherein said leakage scenario simulation module identifies and locates leaks in said liquid distribution network using a leakage identification analytics module and field measurements provided by each of said plurality of hydraulic sensors within each of said plurality of sensor placement configurations.

17. The system of claim 14, wherein said sensor configuration selection module selects a recommended sensor placement configuration from said plurality of sensor placement configurations within limits of at least one of a given budget or a given pool of hydraulic sensors.

18. The system of claim 15, wherein said sensor configuration selection module selects a set of Pareto efficient sensor placement configurations, each of said Pareto efficient sensor placement configurations reflecting a trade-off between said at least one detection performance score and limits of at least one of a given budget or a given pool of hydraulic sensors.

19. The system of claim 14, wherein said leakage scenario simulation module uses one of an internal or an external leakage identification analytics module to detect leaks within said liquid distribution network for each of said plurality of sensor placement configurations.

20. The system of claim 19 wherein said leakage identification analytics module is a hydraulic solver.
